(19) United States
(12) Patent Application Publication
(10) Pub. No.: US 2017/0364324 A1
(43) Pub. Date: Dec. 21, 2017

(54) PORTABLE DEVICE AND CONTROL METHOD THEREFOR

(71) Applicant: LG ELECTRONICS INC., Seoul (KR)

(72) Inventors: Doyoung LEE, Seoul (KR); Jongho KIM, Seoul (KR); Sihwa PARK, Seoul (KR); Juhwan LEE, Seoul (KR); Sinae CHUN, Seoul (KR)

(73) Assignee: LG Electronics Inc., Seoul (KR)

(21) Appl. No.: 15/537,832

(22) PCT Filed: Dec. 23, 2014
(86) PCT No.: PCT/KR2014/012739

§ 371 Date: Jun. 19, 2017

(51) Int. Cl. G06F 3/16; G06F 3/01; G06F 3/0484

(52) U.S. Cl. CPC G06F 3/167; G06F 3/04847; G06F 3/013; G06F 3/016; G06F 3/04842

(57) ABSTRACT

A control method for a portable device, comprising: receiving a first voice input including a first part for executing a first operation and a second part for indicating a first execution level for the first operation; executing the first operation at the first execution level based on the first voice input; receiving a second voice input including only the first part for executing the first operation; displaying a first interface in response to the second voice input when a display of the portable device is in an activated state; detecting a control input for selecting a second execution level from the first interface; executing the first operation at the second execution level based on the detected control input and executing the first operation at a default level in response to the second voice input; when the display is in a deactivated state.

### TECHNICAL FIELD

The present specification relates to a portable device and a control method therefor.

### BACKGROUND ART

Recently, use of portable devices has been increased. The portable device may detect various inputs and execute an operation on the basis of the detected input. At this time, the portable device may detect a voice input as an input. In this case, a method for enabling a portable device to detect a voice input and execute an operation will be required.

### DISCLOSURE

### Technical Problem

An object of the present specification is to provide a portable device and a control method therefor.

Also, another object of the present specification is to provide a method for enabling a portable device to execute an operation on the basis of a voice input.

Also, still another object of the present specification is to provide a method for enabling a portable device to execute an operation on the basis of activation or deactivation of a display unit.

Also, further still another object of the present specification is to provide a method for enabling a portable device to execute an operation at a default level if the portable device detects a voice input in a state that a display unit is not activated.

Also, further still another object of the present specification is to provide a method for enabling a portable device to display an interface indicating information on an operation and an execution level of the operation.

Also, further still another object of the present specification is to provide a method for enabling a portable device to control an activated state of a display unit on the basis of a user's eyes.

Also, further still another object of the present specification is to provide a method for enabling a portable device to control an activated state of a display unit based on whether a user wears the portable device.

Also, further still another object of the present specification is to provide a method for enabling a portable device to execute an operation using an external device.

Also, further still another object of the present specification is to provide a method for enabling a portable device to provide a feedback for an operation executed based on a voice input.

Also, further still another object of the present specification is to provide a method for enabling a portable device to detect status recognition information and execute an operation on the basis of the detected status recognition information.

### Technical Solution

A portable device may be provided in accordance with one embodiment of the present specification. At this time, the portable device comprises an audio sensing unit detecting a voice input and delivering the detected voice input to a processor; a display unit displaying visual information; a control input sensing unit detecting a control input and delivering the detected control input to the processor; and a processor controlling the audio sensing unit, the display unit and the control input sensing unit. In this case, if the processor detects a first voice input including a first part for executing a first operation and a second part for indicating a first execution level for the first operation, the processor executes the first operation at the first execution level on the basis of the first voice input, if the processor detects a second voice input including only the first part for executing the first operation is detected and the display unit is in an activated state, the processor displays a first interface for indicating execution level information on the first operation, detects a control input for selecting a second execution level from the first interface and executes the first operation at the second execution level on the basis of the detected control input, and if the display unit is in a deactivated state, the processor executes the first operation at a default level on the basis of the second voice input.

A control method for a portable device according to one embodiment of the present invention comprises the steps of detecting a first voice input including a first part for executing a first operation and a second part for indicating a first execution level for the first operation; executing the first operation at the first execution level on the basis of the first voice input; detecting a second voice input including only the first part for executing the first operation; if a display unit is in an activated state, displaying a first interface for indicating execution level information on the first operation, detecting a control input for selecting a second execution level from the first interface, and executing the first operation at the second execution level on the basis of the detected control input; and if the display unit is in a deactivated state, executing the first operation at a default level on the basis of the second voice input.

### Advantageous Effects

The present specification may provide a portable device and a control method therefor.

Also, according to the present specification, the portable device may execute an operation on the basis of a voice input.

Also, according to the present specification, the portable device may execute an operation on the basis of activation or deactivation of a display unit.

Also, according to the present specification, the portable device may execute an operation at a default level if the portable device detects a voice input in a state that a display unit is not activated.

Also, according to the present specification, the portable device may display an interface indicating information on an operation and an execution level of the operation.

Also, according to the present specification, the portable device may control an activated state of a display unit on the basis of a user's eyes.

Also, according to the present specification, the portable device may control an activated state of a display unit based on whether a user wears the portable device.

Also, according to the present specification, the portable device may execute an operation using an external device.

Also, according to the present specification, the portable device may provide a feedback for an operation executed based on a voice input.

Also, according to the present specification, the portable device may detect status recognition information and execute an operation on the basis of the detected status recognition information.

### BRIEF DESCRIPTION OF THE DRAWINGS

FIG. 1 is a block diagram illustrating a portable device according to one embodiment of the present specification.

FIG. 2 is a view illustrating a voice recognition system in accordance with one embodiment of the present specification.

FIGS. 3a and 3b are views illustrating a method for executing an operation on the basis of a voice input in a portable device in accordance with one embodiment of the present specification.

FIGS. 4a and 4b are views illustrating a method for executing an operation on the basis of a voice input in a portable device in a state that a display unit is activated in accordance with one embodiment of the present specification.

FIGS. 5a and 5b are views illustrating a method for executing an operation on the basis of a voice input in a portable device in a state that a display unit is deactivated in accordance with one embodiment of the present specification.

FIGS. 6a and 6b are views illustrating a method for enabling a portable device to activate a display unit in accordance with one embodiment of the present specification.

FIG. 7 is a view illustrating a method for enabling a portable device to display an interface indicating information on an operation in accordance with one embodiment of the present specification.

FIGS. 8a and 8b are views illustrating a method for enabling a portable device to provide a feedback on the basis of a voice input in accordance with one embodiment of the present specification.

FIG. 9 is a view illustrating a method for enabling a portable device to execute an operation on the basis of a voice input in accordance with one embodiment of the present specification.

FIG. 10 is a view illustrating status recognition information detected by a portable device in accordance with one embodiment of the present specification.

FIG. 11 is a view illustrating a control method for a portable device in accordance with one embodiment of the present specification.

FIG. 12 is a view illustrating a control method for a portable device in accordance with one embodiment of the present specification.

### BEST MODE FOR CARRYING OUT THE INVENTION

Hereinafter, although the embodiments of the present specification will be described in detail with reference to the accompanying drawings and the disclosure described by the drawings, it is to be understood that claims of the present specification are not limited by such embodiments.

Although the terms used in this specification are selected from generally known and used terms considering their functions in the present specification, the terms may be modified depending on intention of a person skilled in the art, practices, or the advent of new technology. Also, in special case, the terms mentioned in the description of the present specification may be selected by the applicant at his or her discretion, the detailed meanings of which are described in relevant parts of the description herein. Accordingly, the terms used herein should be understood not simply by the actual terms used but by the meaning lying within and the description disclosed herein.

Although the terms such as “first” and/or “second” in this specification may be used to describe various elements, it is to be understood that the elements are not limited by such terms. The terms may be used to identify one element from another element. For example, the first element may be referred to as the second element, and vice versa within the range that does not depart from the scope of the present specification.

In the specification, when a part “comprises” or “includes” an element, it means that the part further comprises or includes another element unless otherwise mentioned. Also, the term “ . . . unit” or “ . . . module” disclosed in the specification means a unit for processing at least one function or operation, and may be implemented by hardware, software or combination of hardware and software.

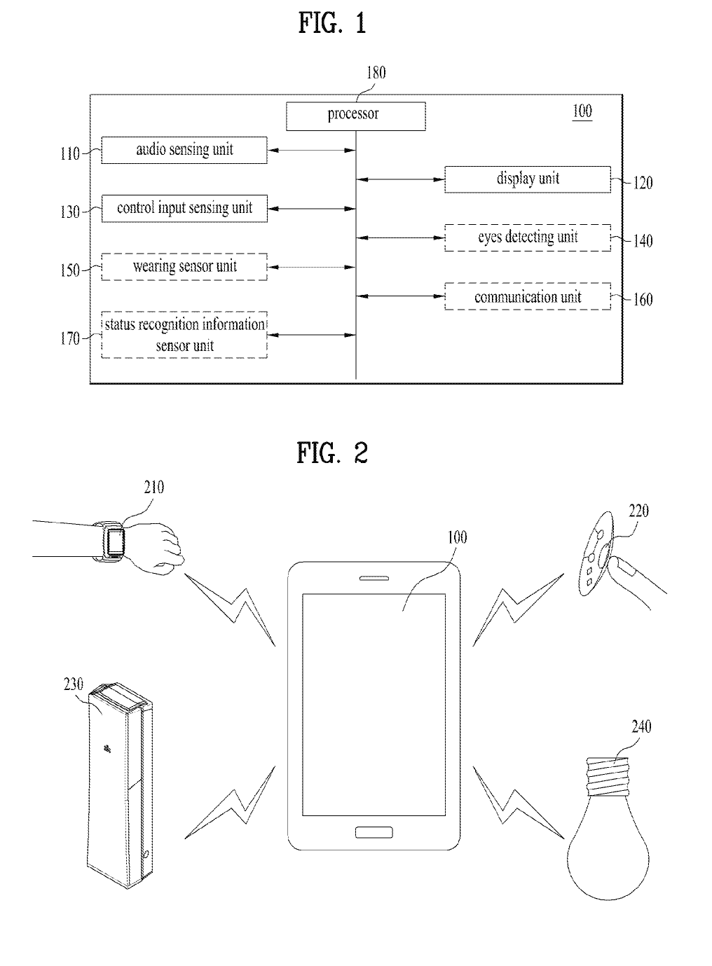

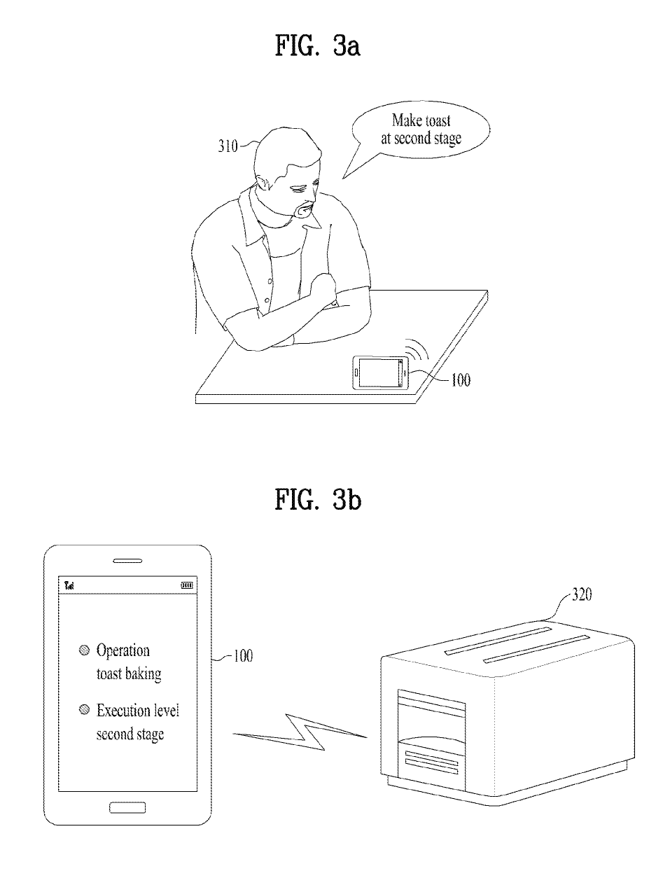

FIG. 1 is a block diagram illustrating a portable device according to one embodiment of the present specification. At this time, the portable device 100 may be a device that may execute voice recognition. For example, the portable device 100 may be a smart phone, a smart pad, a notebook computer, an HMD, a smart watch, or the like. Also, the portable device 100 may be a new device that executes voice recognition. That is, the portable device may be a device that may execute voice recognition, and is not limited to the aforementioned examples. Also, the portable device 100 may be operated as one system with an external device that executes an operation. This will be described with reference to FIG. 2.

The portable device 100 may comprise an audio sensing unit 110, a display unit 120, a control input sensing unit 130, and a processor 180. Also, the portable device 100 may further comprise an eyes detecting unit 140 as an optional element. Also, the portable device 100 may further comprise a wearing sensor unit 150 as an optional element. Also, the portable device 100 may further comprise a communication unit 160 as an optional element. Furthermore, the portable device 100 may further comprise a status recognition information sensing unit 170 as an optional element.

The portable device 100 may comprise the audio sensing unit 110. At this time, the audio sensing unit 110 may be a unit controlled by the processor 180. For example, the audio sensing unit 110 may detect a voice input in the periphery of the portable device 100. For example, the portable device 100 may detect a voice input using a microphone. That is, the portable device 100 may detect a sound in the periphery thereof and use the detected sound as an input, and the input is not limited to the aforementioned example.

The portable device 100 may comprise the display unit 120. At this time, the display unit 120 may be controlled by the processor 180. The portable device 100 may display visual information thereon by using the display unit 120. At this time, the display unit 120 may include at least one of an organic light emitting diode (OLED), a liquid crystal display (LCD), an electronic ink, a head mounted display (HMD), and a flexible display in accordance with the embodiment. That is, the display unit 120 may display visual information on the portable device 100 using a unit provided in the portable device 100. Also, for example, if the portable device 100 is a wearable device, the display unit 120 may display an augmented reality image. That is, the portable device may provide visual information to a user by using the display unit 120, and is not limited to the aforementioned embodiment.

Also, the portable device 100 may comprise the control input sensing unit 130. At this time, the control input sensing unit 130 may be controlled by the processor 180. The control input sensing unit 130 may deliver a user input or an environment recognized by the device to the processor 180 by using at least one sensor mounted in the portable device 100. In more detail, the control input sensing unit 130 may sense a control input of the user by using at least one sensor mounted in the portable device 100. In this case, at least one sensing means may include various sensing means for sensing the control input, such as a touch sensor, a fingerprint sensor, a motion sensor, a proximity sensor, an illumination sensor, a voice recognition sensor, and a pressure sensor. The control input sensing unit 130 refers to the aforementioned various sensing means, and the aforementioned sensors may be included in the portable device 100 as separate elements or may be included in the portable device by being incorporated as at least one or more elements. Also, for example, the control input sensing unit 130 may be an element incorporated with the display unit 120. For example, the control input sensing unit 130 may be a touch sensitive display unit 120. That is, the processor 180 may detect an input for visual information displayed by the display unit 120 through the control input sensing unit 130.

The portable device 100 may further comprise the eyes detecting unit 140 as an optional element. At this time, the eyes detecting unit 140 may be controlled by the processor 180. For example, the eyes detecting unit 140 may detect a user's eyes. At this time, the eyes detecting unit 140 may detect whether the user looks at the portable device 100. If the user's eyes look at the portable device 100 at a threshold time or more, the eyes detecting unit 140 may detect the user's eyes. At this time, the threshold time may be a threshold time for detecting the user's eyes, and may have a certain error range. Also, the eyes detecting unit 140 may deliver the detected eye information to the processor 180.

The portable device 100 may further comprise the wearing sensor unit 150 as an optional element. At this time, the wearing sensor unit 150 may be controlled by the processor 180. For example, the portable device 100 may be a wearable device. At this time, the portable device 100 may detect whether the user wears the portable device 100, by using the wearing sensor unit 150. As an embodiment, the portable device 100 may detect whether the user wears the portable device 100, by using the proximity sensor. Alternatively, the portable device 100 may detect whether the user wears the portable device 100, by using a sensor provided in a joint unit. That is, the portable device 100 of the present invention may determine whether the portable device 100 is worn by the user, using the aforementioned sensor units. At least one of the sensing units that provide the sensed result based on the determined will be referred to as the wearing sensor unit 150 in the present invention.

Also, the portable device 100 may further comprise the communication unit 160 as an optional element. The communication unit 160 may be controlled by the processor 180. At this time, the communication unit 160 may perform communication with an external device using various protocols and thus transmit and receive data. For example, the portable device 100 may transmit a triggering signal for operation execution to the external device through the communication unit 160. That is, the portable device 100 may transmit information from the external device by using the communication unit 160.

Also, the portable device 100 may further comprise the status recognition information sensing unit 170 as an optional element. The status recognition information sensing unit 170 may be controlled by the processor 180. At this time, status recognition information may be information of the status of the user or information on the state of the device. For example, the status recognition information may be position information of the user, time information, motion information or user data information. Also, the status recognition information may be information indicating whether the sensor unit within the portable device 100 is active, or information as to whether a communication network is active, or charging information of the device. That is, the status recognition information may be information on the portable device 100 and a user who uses the portable device 100, and is not limited to the aforementioned examples. At this time, the status recognition information sensing unit 170 may be a sensor unit for sensing the status recognition information. For example, the status recognition information sensing unit 170 may be a GPS that receives position information. Also, for example, the status recognition information sensing unit 170 may be a sensor unit that detect motion of the user. Also, the status recognition information sensing unit 170 may be an audio sensing unit for sensing peripheral sound. That is, the status recognition information sensing unit 170 refers to a sensor unit that may sense information on the portable device 100 and the user, and is not limited to the aforementioned examples.

The processor 180 may be a unit for controlling the audio sensing unit 110, the display unit 120 and the control input sensing unit 130. Also, the processor 180 may be a unit for controlling at least one or more of the eyes detecting unit 140, the wearing sensor unit 150, the communication unit 160 and the status recognition information sensing unit 170. In more detail, the processor 180 may detect a voice input by using the audio sensing unit 110. For example, the voice input may include a first part for executing a first operation and a second part indicating a first execution level for the first operation. The first part may be a command language previously stored as a command language for executing the first operation. Also, the second part may be a command language previously stored as a command language indicating an execution level for the first operation. For example, the execution level for the first operation may be configured based on at least one of attribute, type, operation time and operation method of the first operation. That is, the execution level for the first operation may be a detailed command for the first operation. For example, the first operation may be an operation for making toast. At this time, for example, the first part may be a command language for “toast” and “making operation”. Also, the second part may be baking intensity of toast. For example, if the user says that “make toast at a second stage”, the first part may be “toast” and “make”. Also, the second part may be “second stage”. At this time, the processor 180 may detect a voice input by using the audio sensing unit 110. Also, the processor 180 may execute the first operation at a first execution level on the basis of the voice input. That is, the processor 180 may make toast at the second stage. At this time, the processor 180 may execute the first operation by using the external device. In more detail, the processor 180 may transmit a first triggering signal to the external device by using the communication unit 160 on the basis of the detected voice input. At this time, the first triggering signal may be a signal for a command for executing the first operation with respect to the external device. The external device may execute the first operation on the basis of the first triggering signal. That is, the portable device 100 may control the external device in which the operation is executed, by using the communication unit 160. For example, the processor 180 may transmit the first triggering signal to a toaster, which is the external device, on the basis of the voice input of the user. At this time, the toaster may make toast on the basis of the first triggering signal.

For another example, the processor 180 may detect the status recognition information by using the status recognition information sensing unit 170. At this time, the processor 180 may executed the first operation on the basis of the status recognition information. In more detail, the processor 180 may determine whether to execute the first operation considering the status of the user or the device. Also, for example, the processor 180 may determine an execution level of the first operation considering the status of the user or the device. At this time, as described above, the status recognition information may be user or device information. For example, if time information corresponds to a.m. and position information of the user corresponds to house as the status recognition information, the processor 180 may execute toast baking, which is the first operation, on the basis of the voice input. Also, for example, if time information corresponds to p.m. and position information of the user corresponds to office as the status recognition information, the processor 180 may not execute toast baking, which is the first operation, even though the voice input is detected. That is, the processor 180 may control the first operation and the execution level of the first operation by using the information detected through the status recognition information sensing unit 180.

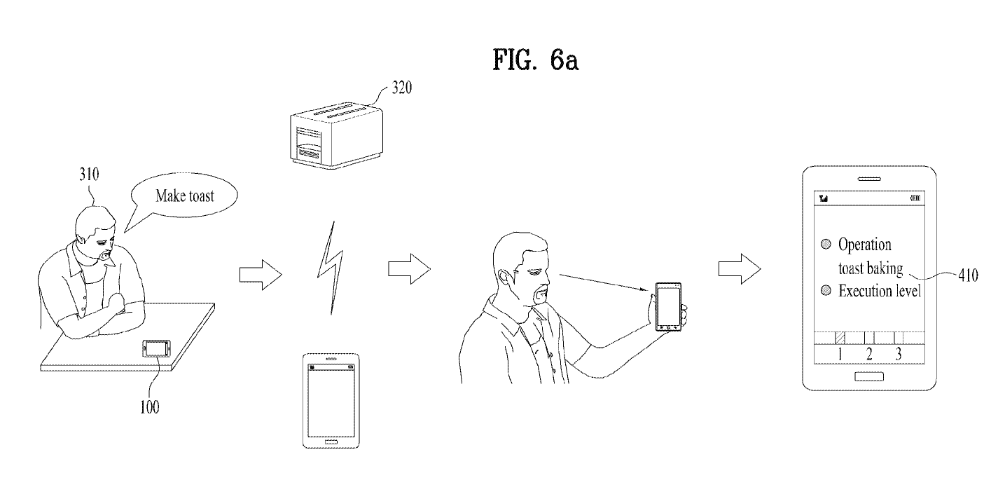

Also, the processor 180 may detect a voice input that includes only the first part for executing the first operation. In more detail, the processor 180 may detect a voice input having no information on the execution level. For example, if the user says “make toast”, the processor 180 cannot determine a desired baking stage of the user. That is, the processor 180 cannot execute the first operation considering the execution level. At this time, for example, if the display unit 120 is activated, the processor 180 may display a first interface indicating execution level information, by using the display unit 120. At this time, the processor 180 may detect a control input for selecting a second execution level from the first interface through the control input sensing unit 130. At this time, the processor 180 may execute the first operation at the second execution level on the basis of the detected control input. For example, the state that the display unit 120 is activated may be a state that the portable device 100 displays visual information through the display unit. That is, the state may be an on-state of the display unit 120. Whether the display unit 120 is activated may not be determined depending on whether a power is supplied to the display unit 120 inside the portable device 100. That is, if the user may view visual information through the display unit 120, the display unit 120 is activated. Also, if the user cannot view visual information through the display unit 120, the display unit 120 is deactivated. At this time, for example, if the processor 180 detects the user's eyes through the eyes detecting unit 140, the display unit 120 may be activated. For another example, if the portable device 100 is worn by the user through the wearing sensor unit 150, the processor 180 may activate the display unit. This will be described with reference to FIGS. 5a and 5b.

Also, for example, if the display unit 120 is deactivated, the processor 180 may execute the first operation at a default level. At this time, the default level may be a default value set by the user or the processor 180. For example, the default level may be set on the basis of the status recognition information. In more detail, the processor 180 may set an optimal condition to the default level considering the status of the user or the device. For example, if the user says “make toast”, the processor 180 may make toast at a second stage which is the default level set by the user. For another example, the processor 180 may set the first stage used most frequently by the user to the default level by using history information of the user. That is, the default level may be information on a level previously set on the basis of the status recognition information.

That is, if the processor 180 detects a voice input that includes only the first part for executing the first operation, the processor 180 may set a method for executing the first operation differently depending on whether the display unit is activated. At this time, if the display unit is activated, the processor 180 may control execution of the first operation through the interface. Also, if the display unit is deactivated, the processor 180 may first execute the first operation at the default level and then control the first operation. This will be described with reference to FIGS. 5a and 5b.

Also, the aforementioned elements may be included in the portable device 100 as separate elements, or may be included in the portable device 100 by being incorporated as at least one or more elements.

FIG. 2 is a view illustrating a voice recognition system in accordance with one embodiment of the present specification. The portable device 100 may be operated as one system with an external device that executes an operation. In more detail, the voice recognition system may include a first device 100 that detects a voice input and transmits a triggering signal for executing an operation on the basis of the detected voice input. At this time, the first device 100 may be the aforementioned portable device 100. The first device 100 may be a device that detects a voice input and controls external devices 210, 220, 230 and 240. That is, the first device 100 controls whether to execute an operation on the basis of a voice input, but may not be a device that directly executes an operation. The voice recognition system may include second devices 210, 220, 230 and 240. The second devices 210, 220, 230 and 240 may be a single device or a plurality of devices. For example, the second devices 210, 220, 230 and 240 may be devices that execute their respective operations. That is, the second devices 210, 220, 230 and 240 may be the devices that receive a triggering signal for an operation from the first device and executes the operation on the basis of the received triggering signal, and are not limited to the aforementioned examples. Also, for example, in the voice recognition system, the first device 100 may control execution of the operation on the basis of the detected voice input. In more detail, the first device 100 may detect a first voice input that includes a first part for executing a first operation and a second part indicating a first execution level for the first operation. At this time, the first device 100 may transmit a first triggering signal to any one of the second devices 210, 220, 230 and 240 on the basis of the first voice input. The first device 100 may transmit the first triggering signal to the second device that may execute the first operation. The second devices 210, 220, 230 and 240 may receive the first triggering signal. At this time, the second devices 210, 220, 230 and 240 may execute the first operation at the first execution level on the basis of the received first triggering signal. That is, if the first device 100 detects a voice input for the first operation and a detailed execution level of the first operation, the second device may execute the operation on the basis of the triggering signal received from the first device 100.

Also, the first device 100 may detect a second voice input that includes only a first part for executing the first operation. That is, the second voice input may not include information on the execution level of the first operation. At this time, if the display unit of the first device 100 is in an activated state, the first device 100 may display a first interface for the execution level of the first operation. At this time, the first device 100 may detect a control input for a second execution level from the first interface. The first device 100 may transmit a second triggering signal to the second devices 210, 220, 230 and 240 on the basis of the control input. At this time, the second devices 210, 220, 230 and 240 may execute the first operation at the second execution level on the basis of the second triggering signal. That is, the first device 100 may control the display unit by displaying information on an execution level if the display unit is in an activated state. For another example, if the display unit of the first device 100 is in a deactivated state, the first device 100 may transmit a third triggering signal to the second devices 210, 220, 230 and 240. At this time, the third triggering signal may be a signal for executing the first operation at a default level. The second devices 210, 220, 230 and 240 may execute the first operation at the default level on the basis of the third triggering signal. That is, the first device 100 may control the display unit to execute the first operation at the default level if the display unit is in a deactivated state. Hereinafter, in this specification, a device that executes an operation by detecting a voice input will be described based on the portable device, and may equally be applied to the voice recognition system.

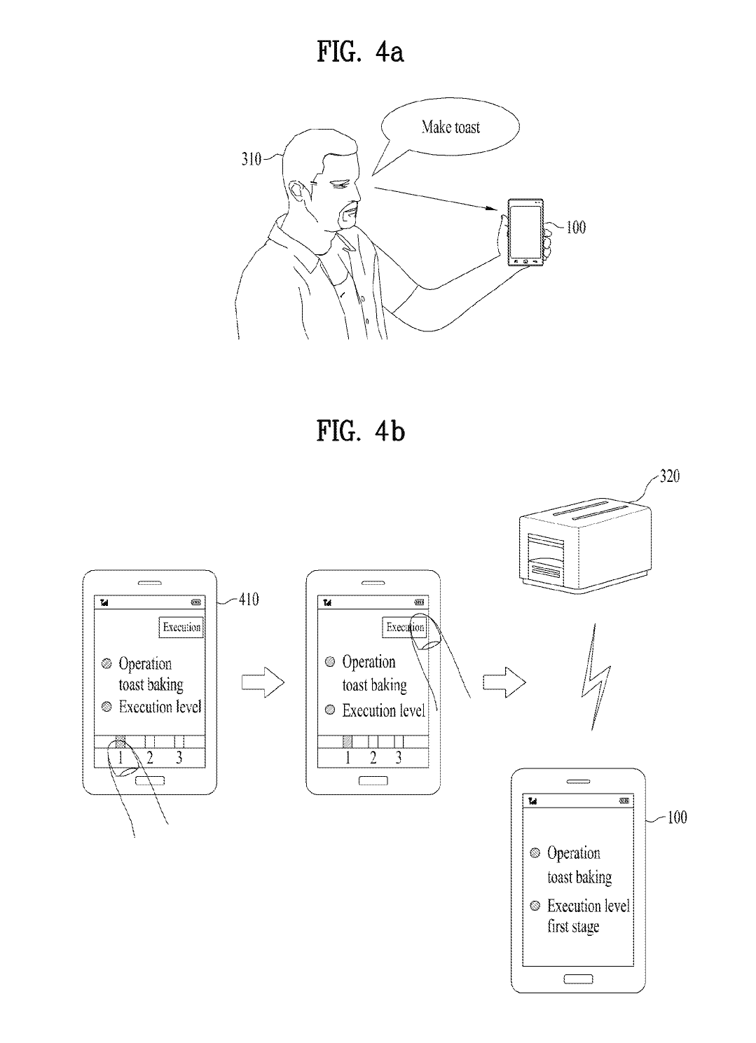

FIGS. 3a and 3b are views illustrating a method for executing an operation on the basis of a voice input in a portable device in accordance with one embodiment of the present specification. The portable device 100 may detect a voice input. At this time, if a command language previously set in the portable device 100 is included in the voice input, the portable device 100 may execute an operation on the basis of the voice input. For example, the portable device 100 may transmit a triggering signal to an external device 320, and may execute the operation using the external device 320 as described above. The portable device 100 may detect a first voice input that includes a first part for executing a first operation and a second part indicating a first execution level for the first operation. That is, the portable device 100 may detect the first voice input that includes a detailed control operation of the first operation. At this time, the portable device 100 may execute the first operation at the first execution level. For example, the portable device 100 may execute the first operation at the first execution level regardless of the fact whether the display unit 120 is activated. That is, the portable device 100 may execute a detailed operation on the basis of a detailed voice input.

For example, referring to FIGS. 3a and 3b, the portable device 100 may detect a voice input of “make toast at a second stage”. At this time, the first part may be “toast” and “make”. Also, the second part may be “second stage”. The portable device 100 may make toast at a second stage using a toaster 320 which is an external device. At this time, for example, the portable device 100 may display information on the first operation.

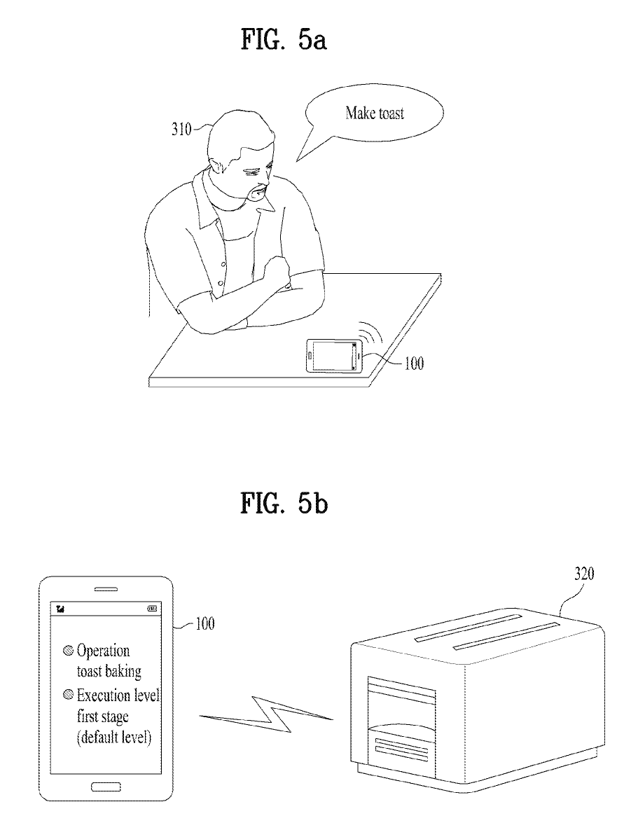

FIGS. 4a and 4b are views illustrating a method for executing an operation on the basis of a voice input in a portable device in a state that a display unit is activated in accordance with one embodiment of the present specification. The portable device 100 may detect a second voice input that includes only a first part for executing a first operation. That is, a user 310 may not perform a command for a detailed operation for an operation. At this time, for example, the display unit 120 of the portable device may be in an activated state. If the display unit 120 provides visual information to the user as described above, the display unit 120 may be in an activated state. That is, the state that the user may view the visual information through the display unit 120 may be in the activated state. At this time, the portable device 100 may display a first interface 410 indicating an execution level for the first operation on the basis of the second voice input. That is, since the user 310 views the portable device 100, the portable device 100 may provide information on the first operation. At this time, the portable device 100 may detect a control input of a user who selects the first execution level. Also, the portable device 100 may detect a control input of a user who executes the first operation. At this time, the portable device 100 may transmit a triggering signal to the external device 320. The external device 320 may execute the first operation at the selected first execution level on the basis of the triggering signal. That is, if the display unit 120 is in an activated state, the portable device 100 may execute the first operation under the control of the user.

FIGS. 5a and 5b are views illustrating a method for executing an operation on the basis of a voice input in a portable device in a state that a display unit is deactivated in accordance with one embodiment of the present specification. The portable device 100 may detect a second voice input that includes only a first part for executing a first operation. At this time, for example, the display unit 120 of the portable device 100 may be in a deactivated state. For example, the deactivated state may be the state that the portable device 100 does not provide visual information. For another example, the deactivated state may be the state that a user's eyes are not detected. In more detail, the portable device 100 may detect the user's eyes using the eyes detecting unit 140. At this time, if the user's eyes are not detected, the portable device 100 may detect the deactivated state. For another example, if the user's eyes are not detected for a threshold time or more, the portable device 100 may detect the deactivated state. At this time, the threshold time may have a certain error.

If the portable device 100 detects the second voice input in the deactivated state, the portable device 100 may execute the first operation at the default level. In more detail, if the user does not view the portable device 100 or does not use the portable device 100, the portable device 100 cannot be controlled by the user. Therefore, the portable device 100 may first execute the first operation at a default level on the basis of the second voice input. At this time, the default level may be a basic value 200 previously set by the user or the processor. For another example, the default level may be a value set based on status recognition information of the user or the device. For example, the default level may be a value having the highest frequency based on history information on a usage record of the user. That is, the default level may be a value that may be set in a state that there is no input of the user. If the portable device 100 detects the second voice input, the portable device may transmit a triggering signal to the external device 320. The external device 320 may execute the first operation at the default level on the basis of the triggering signal. As a result, the user may simply execute the operation even without a detailed control command or operation.

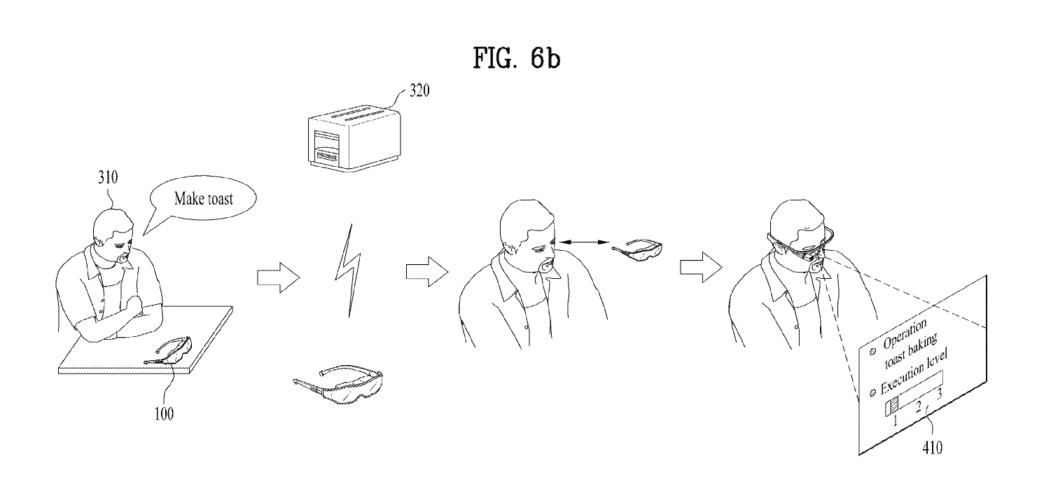

FIGS. 6a and 6b are views illustrating a method for enabling a portable device to activate a display unit in accordance with one embodiment of the present specification. The portable device 100 may execute a first operation at a default level in a state that the display unit is deactivated. At this time, the portable device 100 may detect that the display unit is switched from the deactivated state to the activated state. At this time, the portable device 100 may further display a first interface 410.

For example, referring to FIG. 6a, if the portable device 100 detects a user's eyes using the eyes detecting unit 140, the portable device 100 may switch the display unit 120 from the deactivated state to the activated state. At this time, for example, if the user's eyes are detected for a threshold time or more, the portable device 100 may switch the display unit 120 from the deactivated state to the activated state. That is, if the user is switched to the state that the user views the portable device 100, the portable device 100 may activate the display unit 120.

For another example, referring to FIG. 6b, the portable device 100 may be a wearable device. At this time, the portable device 100 may detect whether the user wears the portable device, through the wearing sensor unit 150. At this time, if it is detected that the portable device 100 is worn by the user, the portable device 100 may switch the display unit 120 from the deactivated state to the activated state. That is, the portable device 100 may determine whether the display unit 120 is activated, depending on whether the user wears the portable device 100.

Also, the portable device 100 may switch the display unit 120 to the activated state in various manners, and is not limited to the aforementioned examples.

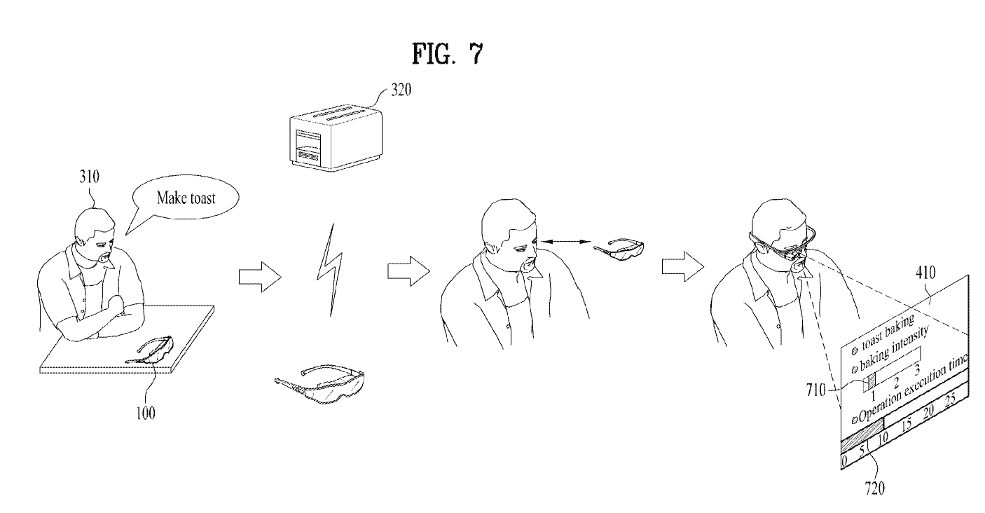

FIG. 7 is a view illustrating a method for enabling a portable device to display an interface indicating information on an operation in accordance with one embodiment of the present specification.

The portable device 100 may detect that the display unit is switched from the deactivated state to the activated state. At this time, the portable device 100 may further display the first interface 410. That is, the portable device 100 first executes the first operation at the deactivated state of the display unit and then display information on the first operation if the display unit is activated. At this time, the portable device 100 may further display a first indicator 710 from the first interface 410 which is displayed. At this time, the first indicator 710 may be an indicator for controlling an execution level for the first operation. At this time, the portable device 100 may detect a control input for the first indicator 710. At this time, the portable device 100 may control the execution level for the first operation on the basis of the control input for the first indicator 710. Also, for example, the portable device may further display a second interface 720. At this time, the second interface 720 may be execution information on the first operation in a state that the display unit 120 is deactivated. In more detail, the portable device 100 may execute the first operation at a default level in a state that the display unit 120 is deactivated. At this time, the user may identify the execution information of the first operation for a time when the display unit 120 is deactivated. Therefore, the portable device may display the second interface 720 indicating the execution information of the first operation if the display unit 120 is switched to the activated state. For example, the second interface 720 may include information on operation time when the first operation is executed, progress information of the first operation, and information as to whether execution of the first operation is completed. That is, the second interface 720 may indicate the information of the first operation in a state that the display unit 120 is deactivated, and is not limited to the aforementioned examples. For another example, the portable device 100 may execute the first operation at the default level and end execution of the first operation if the display unit 120 is not activated within a first threshold time. At this time, the first threshold time may have a certain error. That is, the portable device 100 may end the first operation after the passage of a certain time even without the control operation of the user if the display unit is not activated. As a result, the user may directly control execution and termination of the first operation.

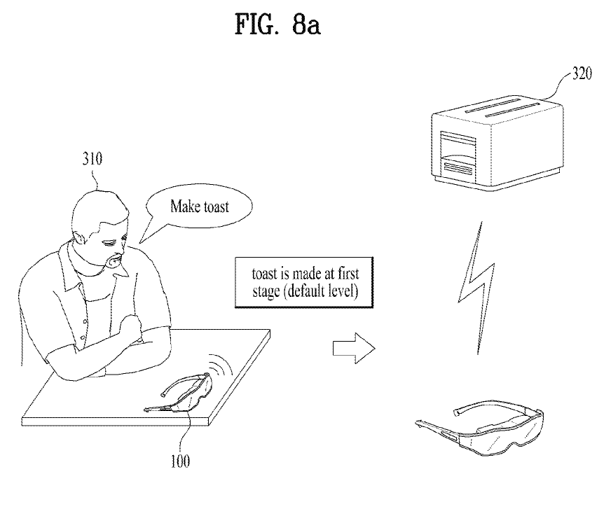

FIGS. 8a and 8b are views illustrating a method for enabling a portable device to provide a feedback on the basis of a voice input in accordance with one embodiment of the present specification. If the portable device 100 executes a first operation at a default level, the portable device 100 may provide a feedback for the first operation. At this time, the feedback may include at least one of visual feedback, audio feedback, and tactile feedback. That is, the feedback may be information provided to the user, and is not limited to the aforementioned examples.

For example, referring to FIG. 8a, the feedback may be audio feedback. At this time, the portable device 100 may provide whether the first operation is executed, through the feedback. For example, the first operation may be an operation for making toast. At this time, the portable device 100 may provide a user with an audio feedback indicating that “toast is made at a first stage (default level)”. As a result, the user may identify whether the first operation is executed, even in a state that the display unit 120 is not activated.

For another example, referring to FIG. 8b, the portable device 100 may provide a feedback for an execution level of the first operation. At this time, the portable device 100 may detect a voice input, which includes information on a second execution level, on the basis of the feedback. At this time, the portable device 100 may execute the first operation at the second execution level. For example, the first operation may be an operation for making toast. At this time, the portable device 100 may provide the user with a feedback indicating that “what stage do you want to make toast?”. At this time, the portable device 100 may detect a voice input of the user, which indicates “second stage”. The voice input may be information on the execution level of the first operation. At this time, the portable device 100 may make toast at the second stage. That is, the portable device 100 may execute the first operation considering the execution level. As a result, the user may execute the operation even in a state that the display unit 120 is not activated.

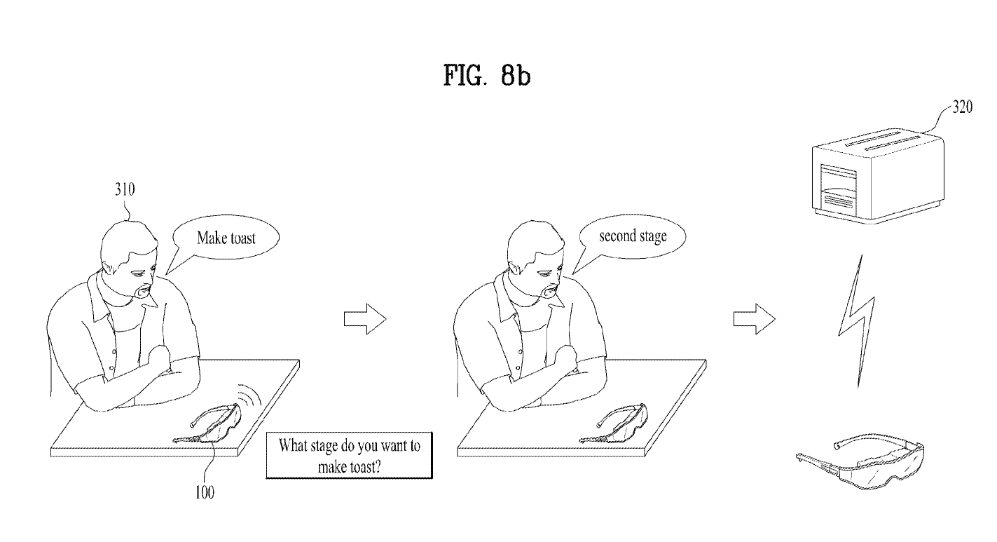

FIG. 9 is a view illustrating a method for enabling a portable device to execute an operation on the basis of a voice input in accordance with one embodiment of the present specification. The portable device 100 may detect a voice input and execute an operation on the basis of the detected voice input. At this time, the portable device 100 may detect a voice input on the basis of an operation standby mode. In more detail, if the portable device always detects a voice input, the portable device may execute an operation on the basis of a voice input which is not intended by a user. Therefore, the portable device 100 needs to execute an operation with respect to only a voice input intended by the user. For example, the portable device 100 may detect a third voice input and set an operation standby mode on the basis of the detected third voice input. At this time, for example, the third voice input may be a command language for executing a previously set command language or the operation standby mode. Also, the operation standby mode may be a standby state that the portable device 100 executes the operation. That is, the portable device 100 may execute the operation on the basis of the voice input only in the operation standby state.

For example, referring to FIG. 9, the portable device 100 may detect a voice input indicating “K, make toast”. At this time, the portable device 100 may execute the operation using the toaster 320 which is an external device. Also, the portable device 100 may detect a voice input indicating “make toast”. At this time, the portable device 100 may not execute the operation using the toaster 320 which is an external device. That is, the portable device 100 may execute the operation only if the portable device 100 detects a command language for the operation after detecting a command language indicating “K” for executing the operation standby mode. As a result, the user may prevent the operation from being executed based on an unwanted voice input.

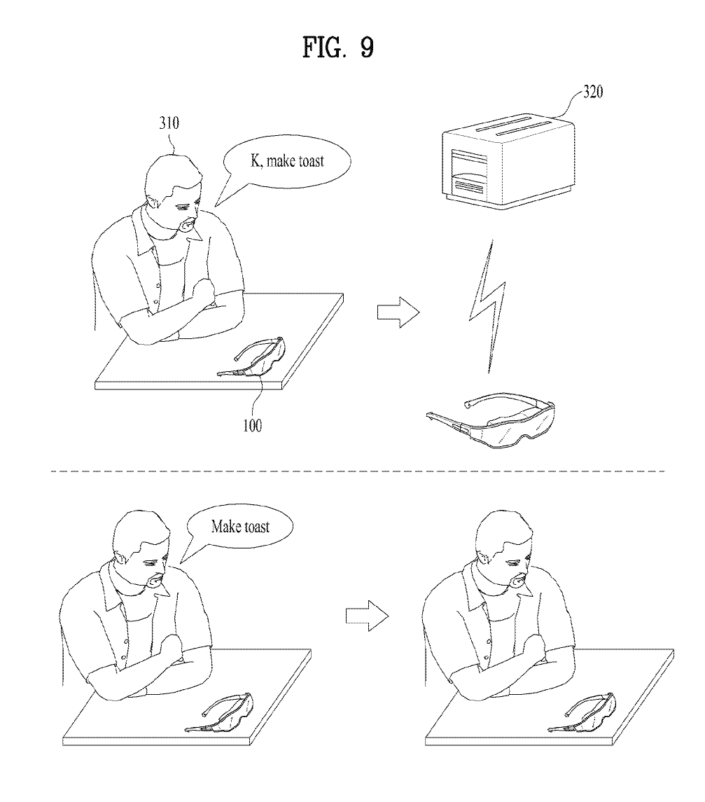

FIG. 10 is a view illustrating status recognition information detected by a portable device in accordance with one embodiment of the present specification. The portable device 100 may detect status recognition information by using the status recognition information sensing unit 170. Also, the portable device 100 may execute an operation on the basis of the detected status recognition information. For example, the status recognition information may be state information of the user or the device. Also, for example, the status recognition information sensing unit 170 may be an audio sensing unit 110 that detects voice information. For another example, the status recognition information may be information based on big data. For example, the portable device 100 may receive big data information on the user or the device through the communication unit 160. At this time, the big data information may include lifestyle information of the user, history information on operation execution, operation executable device information, etc. That is, the status recognition information is information that may be used by the portable device 100, and may be information that may identify a surrounding environment and is not limited to the aforementioned example.

For example, referring to FIG. 10, the status recognition information may include at least one of position information of a user, time information, motion information of a user, and user data information. Also, the status recognition information may include at least one of activity information of the sensor unit, communication network information, and charging information of the device, as information on the device. At this time, if the detected status recognition information satisfies a first setup value, the portable device 100 may control whether to execute a first operation, on the basis of surrounding status information. For example, the first operation may be an operation for making toast. At this time, the portable device 100 may execute the first operation on the basis of the status recognition information. For example, the portable device 100 may execute the first operation on the basis of a voice input only if the user is located in his/her house and time is in a time range previously set to the user's attending time to work. That is, the portable device 100 may execute the first operation in case of only a specific condition on the basis of the status recognition information. Also, for example, the portable device 100 may set a default level of the first operation on the basis of the status recognition information. For example, the portable device 100 may set a level executed most frequently among execution levels of the first operation to the default level on the basis of history information. That is, the portable device 100 may set whether the first operation is executed or the default level of the first operation, on the basis of the status recognition information, and is not limited to the aforementioned examples.

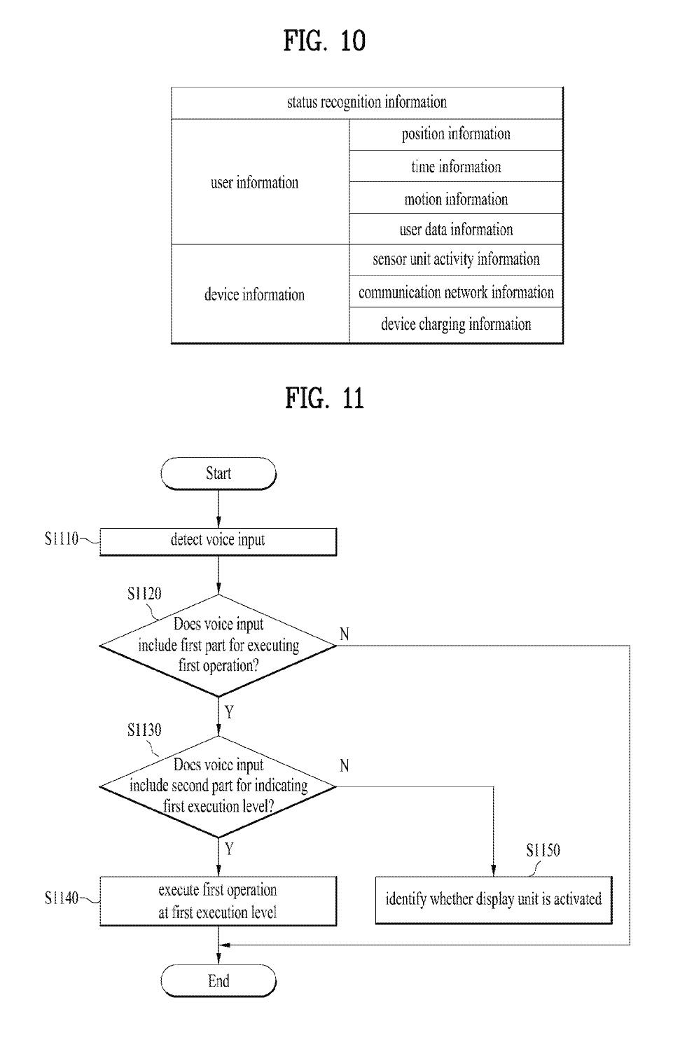

FIG. 11 is a view illustrating a control method for a portable device in accordance with one embodiment of the present specification. The portable device 100 may detect a voice input (S1110). At this time, as described in FIG. 1, the portable device 100 may detect the voice input by using the audio sensing unit 110.

Next, the portable device 100 may detect whether a first part for executing a first operation is included in the detected voice input (S1120). At this time, as described in FIG. 1, the first part may be a part for executing the first operation. At this time, the first part may be a part previously set by the user or the processor 180. At this time, the portable device 100 may execute the first operation if the previously set first part is included in the voice input.

Next, the portable device 100 may detect whether a second part indicating a first execution level for the first operation is included in the detected voice input (S1130). At this time, as described in FIG. 1, the second part may be a part for indicating the first execution level of the first operation. In more detail, the second part may be a detailed command part for the first operation.

Next, if the second part indicating the first execution level is included in the voice input, the portable device 100 may execute the first operation at the first execution level (S1140). At this time, as described in FIGS. 3a and 3b, if the portable device 100 detects a voice input for an operation and a detailed execution level for the operation, the portable device 100 may execute the operation on the basis of the voice input. At this time, the portable device 100 may execute the operation regardless of the fact that the display unit is activated. That is, if the portable device 100 detects the part for the first execution level which is a detailed command for the first operation, the portable device 100 may execute the first operation at the first execution level.

Next, if the second part indicating the first execution level is not included in the voice input, the portable device 100 may detect whether the display unit is activated (S1150). At this time, as described in FIG. 1, the portable device 100 may detect whether the display unit 120 is activated, through the eyes detecting unit 140. Also, if the portable device 100 is a wearable device, the portable device 100 may detect whether the display unit 120 is activated, through the wearing sensor unit 150.

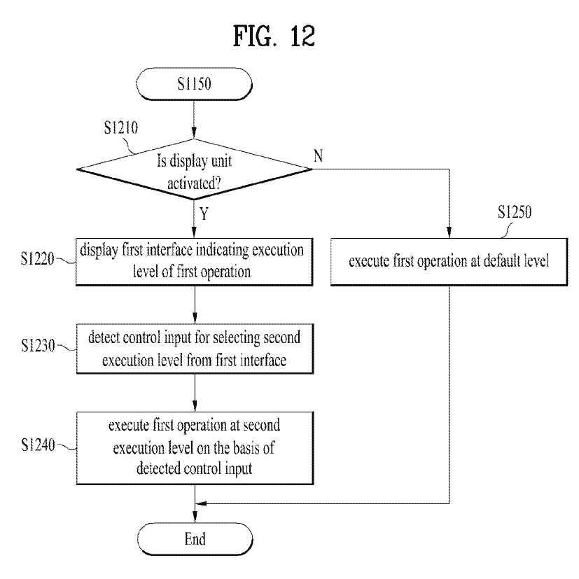

FIG. 12 is a view illustrating a control method for a portable device in accordance with one embodiment of the present specification. The portable device 100 may detect whether the display unit is activated (S1210). At this time, as described in FIG. 1, the activated state of the display unit 120 may be the state that the portable device 100 may provide a user with visual information. That is, the state that the user may view the visual information through the portable device 100 may be the state that the display unit 120 is activated.

Next, if the portable device 100 is in an activated state, the portable device 100 may display a first interface indicating an execution level of a first operation (S1220). At this time, as described in FIG. 7, the first interface may be an interface indicating a detailed execution method of the first operation. At this time, the first interface may include a first indicator. The first indicator may be an indicator for controlling an execution level of the first operation. The portable device 100 may control the execution level of the first operation on the basis of a control input for the first indicator.

Next, the portable device 100 may detect a control input for selecting a second execution level from the first interface (S1230). At this time, as described in FIG. 1, the portable device 100 may detect a control input for selecting the second execution level by using the control input sensing unit 130. That is, since the display unit 120 is activated, the portable device 100 may set a detailed execution level by displaying a control interface for the first operation.

Next, the portable device 100 may execute the first operation at the second execution level on the basis of the detected control input (S1240). At this time, as described in FIG. 1, the portable device 100 may transmit a triggering signal to the external device on the basis of the voice input. At this time, the external device may execute the first operation at the second execution level on the basis of the received triggering signal. That is, the portable device 100 may be a control device for executing the first operation. At this time, the external device may be a device for executing the first operation by means of the portable device 100.

Next, if the portable device 100 is in an deactivated state, the portable device 100 may execute the first operation at a default level (S1250). At this time, as described in FIG. 1, since the display unit 120 is activated, the portable device 100 may first execute the first operation. At this time, the default level may be a value previously set by the user or the processor 180. Also, the default level may be a value set on the basis of the status recognition information. At this time, the portable device 100 cannot provide the user with an interface for the first operation as the display unit 120 is deactivated. Therefore, the portable device 100 may first execute the first operation at the default level. At this time, if the display unit is switched from the deactivated state to the activated state, the portable device 100 may further display the first interface.

For another example, if the portable device 100 executes the first operation at the default level, the portable device 100 may provide a feedback for the first operation. At this time, the feedback may include at least one of visual feedback, audio feedback and tactile feedback.

Moreover, for convenience of description, although the description has been made for each of the drawings, the embodiments of the respective drawings may be incorporated to achieve a new embodiment. A computer readable recording medium where a program for implementing the aforementioned embodiments is recorded may be designed in accordance with the need of the person skilled in the art within the scope of the present invention.

The portable device 100 and the control method therefor according to the present invention are not limited to the aforementioned embodiments, and all or some of the aforementioned embodiments may selectively be configured in combination so that various modifications may be made in the aforementioned embodiments.

Meanwhile, the portable device 100 and the control method therefor according to the present specification may be implemented in a recording medium, which may be read by a processor provided in a network device, as a code that can be read by the processor. The recording medium that can be read by the processor includes all kinds of recording media in which data that can be read by the processor are stored. Examples of the recording medium include a ROM, a RAM, a CD-ROM, a magnetic tape, a floppy disk, and an optical data memory. Also, another example of the recording medium may be implemented in a shape of carrier wave such as transmission through Internet. Also, the recording medium that can be read by the processor may be distributed in a computer system connected thereto through the network, whereby codes that can be read by the processor may be stored and implemented in a distributive mode.

It will be apparent to those skilled in the art that the present specification can be embodied in other specific forms without departing from the spirit and essential characteristics of the specification. Thus, the above embodiments are to be considered in all respects as illustrative and not restrictive. The scope of the specification should be determined by reasonable interpretation of the appended claims and all change which comes within the equivalent scope of the specification are included in the scope of the specification.

In this specification, both the product invention and the method invention have been described, and description of both inventions may be made complementally if necessary.

### MODE FOR IMPLEMENTING THE INVENTION

—

### INDUSTRIAL APPLICABILITY

The present invention has industrial applicability, which can be used for a terminal device and has reproducibility.

1. A portable device comprising:
an audio sensing unit configured to detect a voice input;
a display configured to display visual information;
a control input sensing unit configured to detect a control input; and
a processor operably coupled to the audio sensing unit, the display, and the control input sensing unit and configured to:
receive a first voice input detected by the audio sensing unit, the first voice input including a first part for executing a first operation and a second part for indicating a first execution level for the first operation;
execute the first operation at the first execution level based on the first voice input;
receive a second voice input detected by the audio sensing unit, the second voice input including only the first part for executing the first operation;
cause the display to display a first interface for indicating execution level information on the first operation in response to the second voice input when the display is in an activated state;
receive the control input detected by the control input sensing unit, wherein the control input is for selecting a second execution level from the first interface;
execute the first operation at the second execution level based on the control input; and
execute the first operation at a default level in response the second voice input when the display is in a deactivated state.

2. The portable device according to claim 1, wherein the processor is further configured to cause the display to display the first interface when the display is switched from the deactivated state to the activated state.

3. The portable device according to claim 2, wherein the processor is further configured to:
cause the display to display a first indicator via the first interface;
receive a second control input for the first indicator detected by the control input sensing unit; and
control an execution level for the first operation based on the second control input.

4. The portable device according to claim 2, wherein the processor is further configured to cause the display to display a second interface, the second interface indicating execution information of the first operation for a time when the display is activated.

5. The portable device according to claim 2, further comprising an eyes detecting unit configured to detect a user's eyes,
wherein the processor is further configured to switch the display from the deactivated state to the activated state when the user's eyes are detected by the eyes detecting unit.

6. The portable device according to claim 5, wherein the processor is further configured to switch the display to the activated state when the user's eyes are detected for at least a preset threshold time.

7. The portable device according to claim 2, further comprising a wearing sensor unit configured to detect whether the portable device is worn by a user,
wherein the processor is further configured to switch the display from the deactivated state to the activated state when the wearing sensor unit detects that the portable device is worn by the user.

8. The portable device according to claim 1, further comprising a communication unit configured to exchange information with an external device,
wherein executing the first operation comprises transmitting a first triggering signal for the first operation to the external device, causing the external device to execute the first operation based on the first triggering signal.

9. The portable device according to claim 1, wherein the processor is further configured to:
execute the first operation at the default level; and
stop executing the first operation when the display is not activated within a preset threshold time.

10. The portable device according to claim 1, wherein the processor is further configured to provide a feedback for the first operation when the processor executes the first operation at the default level.

11. The portable device according to claim 10, wherein the feedback includes at least one of a visual feedback, an audio feedback, or a tactile feedback.

12. The portable device according to claim 10, wherein the processor is further configured to execute the first operation at a third execution level based on the feedback of the first operation in response to detection of a third voice input by the audio sensing unit, the third voice input including a third part related to the third execution level of the first operation.

13. The portable device according to claim 1, wherein the processor is further configured to:
receive a third voice input for executing an operation standby mode detected by the audio sensing unit; and
execute the operation standby mode based on the third voice input.

14. The portable device according to claim 13, wherein the processor is further configured to execute the first operation in response to any one of the first voice input and the second voice input that is detected in the operation standby mode.

15. The portable device according to claim 1, further comprising a status recognition information sensing unit configured to sense status recognition information on the portable device.

16. The portable device according to claim 15, wherein the processor is further configured to:
detect the status recognition information; and
execute the first operation when the status recognition information satisfies a preset setup value.

17. The portable device according to claim 16, wherein the status recognition information includes at least one of position information, time information, sound information, motion information, or device state information.

18. The portable device according to claim 1, wherein the first or second execution level of the first operation is set based on at least one of a type, an operation time, an operation method, or an attribute of the first operation.

19. A voice recognition system comprising:
a first device detecting a voice input and controlling whether to execute an operation by generating a triggering signal; and
a second device receiving the triggering signal from the first device and executing the operation based on the received triggering signal,
wherein:
the first device transmits a first triggering signal to the second device when the first device detects a first voice input including a first part for executing a first operation and a second part for indicating a first execution level for the first operation, and the second device executes the first operation at the first execution level based on the first triggering signal received from the first device;
the first device displays a first interface for indicating execution level information on the first operation when the first device detects a second voice input including only the first part for executing the first operation and when a display of the first device is in an activated state, the first device detects a control input for selecting a second execution level from the first interface and transmits a second triggering signal to the second device based on the detected control input, and the second device executes the first operation at the second execution level based on the second triggering signal received from the first device; and
the first device transmits a third triggering signal to the second device when the display is in a deactivated state, and the second device executes the first operation at a default level based on the third triggering signal received from the first device.

20. A control method for a portable device, comprising:
receiving a first voice input via an audio sensing unit of the portable device, the first voice input including a first part for executing a first operation and a second part for indicating a first execution level for the first operation;
executing the first operation at the first execution level based on the first voice input;
receiving a second voice input via the audio sensing unit, the second voice input including only the first part for executing the first operation;
displaying a first interface for indicating execution level information on the first operation in response to the second voice input when a display of the portable device is in an activated state;
detecting a control input for selecting a second execution level from the first interface;
executing the first operation at the second execution level based on the detected control input; and
executing the first operation at a default level in response to the second voice input when the display is in a deactivated state.
